(19) United States
(12) Patent Application Publication
(10) Pub. No.: US 2007/0140698 A1
(43) Pub. Date: Jun. 21, 2007

(54) Radio frequency signal device biasing circuit

(75) Inventors: Qi Pan, Didcot (GB); Joseph Barnard, London (GB)

Correspondence Address: SUGHRUE MION, PLLC, 2100 PENNSYLVANIA AVENUE, N.W., SUITE 800, WASHINGTON, DC, 20037, US

(73) Assignee: BOOKHAM TECHNOLOGY PLC

(21) Appl. No.: 11/311,543

(22) Filed: Dec. 20, 2005

(51) Int. Cl. H04B 10/00

(52) U.S. Cl. 398/115

(57) ABSTRACT

A circuit including a pair of radio frequency signal devices to each of which are connected in parallel a respective input or output and a respective dc bias input device for biasing the respective radio frequency signal device; each dc bias input device including a radio frequency transistor and at least two different types of inductors.

### FIELD OF THE INVENTION

The present invention relates to a radio frequency signal biasing circuit, particularly but not exclusively to a pull-up circuit for a differential optical device driver.

### BACKGROUND OF THE INVENTION

Optical devices used in optical communications systems are generally driven with electrical signals in order to generate the optical signals. Driver circuits are available that can provide the required electrical signals to drive an optical device such as a laser diode or an external modulator. These optical device driver circuits are often available as integrated circuit (IC) packages, and can be easily incorporated into a driver system design.

An optical device driver circuit typically provides a modulation current to the optical device that switches the optical device between two or more states in order to convey communication information. The modulation current is typically a radio frequency (RF) signal.

An optical device driver system can typically provide the modulation current to an optical device either with a “single-ended” drive or a “differential” drive. With a single-ended drive, the modulation current is driven through the optical device in a single direction at different levels. With a differential driver, the modulation current is driven through the optical device in forward and reverse directions, or one output drives the optical device and the other output drives a dummy load. A general advantage of using differential drive is that the optical device can switch between states faster than with a single-ended driver. Differential drive also has the advantage of generating less electromagnetic emission, which means that there is less cross-talk from the transmitter to the receiver, and reduced atmospheric emission (to comply with FCC regulations and industry standards).

A typical optical device driver circuit for differential drive typically comprises two complementary outputs (often denoted + and −) for driving the modulation current in forward and reverse directions, or for driving an optical device and a dummy load at the same time. The output stage of a typical optical device driver circuit for differential drive usually comprises a pair of transistors, one for each of the complementary outputs. These transistors are often connected in an open-collector configuration or may have a back terminating resistor between the collector and the power supply. In such a configuration, the collector of the output transistor is connected directly to the respective output of the optical device driver. In order for the transistor to operate, the collector connected to the output is biased using a dc voltage. This is achieved using a “pull-up” circuit.

An optical device driver system 100 with a known pull-up circuit is shown in FIG. 1. A differential driver circuit 102 (such as a differential driver IC) has complementary inputs 104, 106 connected via AC-coupling capacitors 108, 110. The output stage of the differential driver 102 also receives a DC supply voltage VCC at 112. The differential driver has two complementary open-collector outputs 114, 116. As stated above, these outputs need to be “pulled-up” by the supply voltage VCC, in order to bias the transistors in the output stage of the differential driver 102. This has been achieved through the use of inductors 118, 120, whereby one inductor is connected between one output of the differential driver and VCC, and the other inductor is connected between the other output of the differential driver and VCC.

The inductors 118, 120 provide a low impedance path to the DC supply voltage VCC, thereby ensuring that the open-collector outputs of the differential driver are at a voltage close to the DC supply voltage, thereby biasing the output transistors. The inductors 118, 120 also provide a high impedance to the RF modulation signals from the outputs of the differential driver 102, and this reduces the amount of RF modulation signal that is undesirably diverted away from the optical device 130 connected to outputs 126, 128.

The outputs 114, 116 of the differential driver 102 are also connected to AC-coupling capacitors 122, 124, which provide a low impedance to the RF modulation signals, allowing the RF modulation signal to pass to the outputs 126, 128, for further connection to said optical device, such as a laser diode or an external modulator. The capacitors 122, 124 also provide a high impedance to DC, thereby preventing the DC voltage provided to the outputs of the differential driver 114, 116 from the inductors 118, 120 from entering the outputs 126, 128 and affecting the rest of the system.

### SUMMARY OF THE INVENTION

It has been observed that there is a problem with this conventional approach to providing a pull-up for an optical device driver. If the modulation signal is a wideband RF signal, then it may comprise a range of frequencies from a relatively low RF component up to a relatively high RF component. In order to provide sufficient impedance to the low frequency RF component, a large value inductor was thought to be required, and large value inductors tend to be of a large physical size. Therefore, whilst using large value inductors can improve the impedance over a relatively wide RF frequency range, to do so is not conducive to reducing the size of the circuit and in particular is not conducive to fitting the circuit on a small printed circuit board (PCB) for, for example, a pluggable optical module.

It is an aim of the present invention to provide a new type of radio frequency signal device biasing circuit, and in particular it is an aim of the present invention to provide a new type of radio frequency signal device biasing circuit that can provide a good level of performance over a wide frequency range whilst at the same time being suitable for use in small devices.

It is another aim of the present invention to provide a biasing circuit that is particularly suitable for differential radio frequency signal devices, such as differential optical device drivers.

According to one aspect of the present invention, there is provided a circuit including a pair of radio frequency signal devices to each of which are connected in parallel a respective input or output and a respective dc bias input device for biasing the respective radio frequency signal device; each dc bias input device including a radio frequency transistor and at least two different types of inductors.

In one embodiment, the pair of radio frequency signal devices together constitute part of a differential driver.

In one embodiment, each dc bias input device includes a radio frequency transistor having a F_{T} value greater than or equal to 25 MHz.

In one embodiment, the at least two types of inductors have different Q factors.

In one embodiment, said two types of inductors include a coil inductor and a ferrite bead inductor.

In one embodiment, the two dc bias input devices share a common power supply.

According to another aspect of the present invention, there is provided a system for producing an optical signal, including a pair of radio frequency signal input devices to each of which are connected in parallel a respective output and a respective dc bias input device for biasing the respective radio frequency signal input device; each dc bias input device including a radio frequency transistor and at least two different types of inductors; and further including an optic device connected to at least one of said outputs.

In one embodiment, said optic device is connected to both of said outputs.

In one embodiment, said optic device is connected to only one of said outputs, and a dummy load is connected to another of said outputs.

In one embodiment, the two radio frequency signal input devices constitute part of a differential driver. Providing two different types of inductors in combination with the radio frequency transistor facilitates the use of a radio frequency transistor having a lower transition frequency, and thereby facilitates the provision of a pull-up circuit displaying substantially identical performance for both differential outputs of the differential driver.

In one embodiment, the optical device is a laser diode or an external modulator.

In one embodiment, the two dc bias input devices share a common power supply.

According to another aspect of the present invention, there is provided a circuit including a radio frequency signal device to which are connected in parallel an input or output and a dc bias input device for biasing the radio frequency signal device:
the dc bias input device including a radio frequency transistor and at least two different types of inductors.

In one embodiment, the at least two types of inductors include a coil inductor and a ferrite bead inductor.

In one embodiment, the at least two types of inductors have different Q factors.

In one embodiment, the circuit further includes a capacitive element connected to said input or output in parallel with the dc bias input device and the radio frequency signal device.

According to another aspect of the present invention, there is provided a system for producing an optical signal including: a radio frequency signal input device to which are connected in parallel an optical device for producing an optical signal and a dc bias input device for biasing the radio frequency signal input device, the dc bias input device including a radio frequency transistor and at least two different types of inductors.

In one embodiment, the optical device is a laser diode or an external modulator.

The radio frequency signal device may, for example, be a device for outputting a radio-frequency signal for driving an optical device, or an optical device for receiving a radio-frequency signal.

### BRIEF DESCRIPTION OF THE DRAWINGS

For a better understanding of the present invention and to show how the same may be put into effect, reference will now be made, by way of example, to the following drawings in which:

FIG. 1 shows an optical device driver system including a known pull-up circuit;

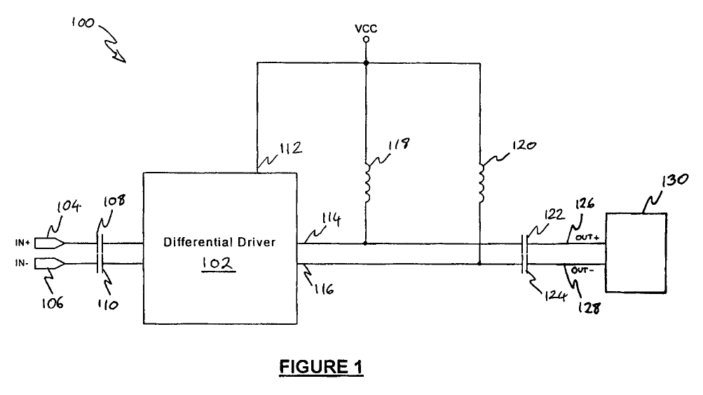

FIG. 2 shows a differential optical device driver system including a hybrid pull-up circuit according to an embodiment of the present invention;

FIG. 3 shows a single-ended optical device driver system including a hybrid pull-up circuit according to another embodiment of the present invention; and

FIG. 4 shows a differential optical device driver system including a hybrid pull-up circuit according to another embodiment of the present invention, but with the optical device connected to only one of the driver outputs and the other driver output being connected to a dummy load.

### DESCRIPTION OF PREFERRED EMBODIMENTS

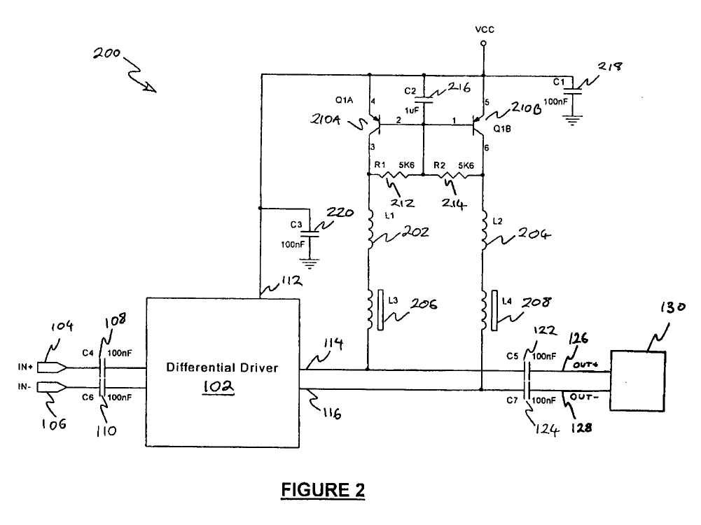

Reference is first made to FIG. 2, in which is shown an optical device driver system 200 including a hybrid pull-up circuit according to an embodiment of the present invention. The system 200 comprises complementary inputs 104, 106 connected to a differential driver 102 (which may be a differential driver IC) via AC-coupling capacitors 108, 110. The differential driver 102 is connected to a DC voltage supply VCC at 112. The output stage of the differential driver 102 has two complementary outputs 114, 116 via which are output the RF modulation signals. The RF modulation signals pass through AC-coupling capacitors 122, 124 (which have low impedance at RF) to outputs 126, 128, from which the RF modulation signals can be passed to an optical device 130, such as a laser diode or an external modulator.

The outputs 114, 116 are open-collector outputs, as described previously, and as discussed below are pulled-up by the supply voltage in order to bias the transistors in the output stage of the differential driver 102.

Identical pull-up circuitry is included for each of the two complementary outputs 114, 116. The pull-up circuitry for the two complementary outputs comprises a high Q inductor, such as a coil inductor (202 for the “+” output 114, 204 for the “−” output 116), a low Q inductor, such as a ferrite bead inductor (206, 208 for the “+” and “−” outputs 114, 116, respectively) and a transistor (210A, 210B for the “+” and “−” outputs 114, 116, respectively). The transistors 210A, 210B are a matched pair of PNP bipolar transistors.

The ferrite bead inductors 206, 208 are connected to the outputs 114, 116 of the differential driver. Ferrite beads have a relatively small physical size and are able to provide high impedance to relatively high frequency RF signals. The ferrite beads are connected to the coil inductors 202, 204, which provide high impedance to mid-low RF frequencies. The combination of the passive ferrite bead inductors in series with the coil inductors provides the desired level of impedance over some of the required RF frequency range. The two different types of inductors give a combination of high Q and low Q inductors. Q is the quality factor for an inductor. Q is given by Q=X/R, where X is the inductive reactance and R is the equivalent series resistance.

The transistors 210A, 210B provide a large impedance at the low frequency part of the wideband RF signal. The frequency range over which the transistor provides a high impedance is related to the transition frequency, f_{T}, of the transistor, wherein the f_{T} value is the theoretical frequency at which the current gain (h_{fe}) of the transistor is unity (i.e. 0 dB).

The collector of transistor 210A is connected to coil inductor 202 and the collector of transistor 210B is connected to coil inductor 204. The emitter of transistors 210A and 210B are connected to the supply voltage VCC. A resistor 212 is connected between the base and the collector of transistor 210A, and a resistor 214 is connected between the base and the collector of transistor 210B. The resistors 212 and 214 bias the transistors 210A, 210B together with the differential driver back termination (which may typically be 75Ω). The values of resistors 212 and 214 are chosen to give the appropriate voltage in the bias circuit, and their values depend upon the back terminating resistor values in the driver 102 and the desired bias voltage. The base terminals of the transistors 210A and 210B are connected together.

A capacitor 216 is connected between the supply voltage VCC and the base terminals of 210A and 210B. The capacitor creates a “virtual battery” which keeps the base emitter bias voltage constant for transistors 210A and 210B. Thus the current is constant in 210A and 210B. Capacitors 218, 220 bleed off any stray AC signals from the supply voltage line.

The type of transistor used for 210A and 210B is deliberately chosen with a view to having two transistors of substantially identical characteristics, even if this means selecting a type of RF transistor that has a transition frequency lower than the highest that is available. In this embodiment, this is made possible by the co-use of the passive inductors 202, 204, 206, 208, which together provide the desired level of impedance over the entire frequency range. A typical value for the transition frequency for the transistors shown in FIG. 2 is ≧250 MHz. Typical values for the inductors are L3, L4=1 K@100 MHz (ferrite beads) and L1, L2=47 μH.

Using the hybrid technique of combining active components (an RF transistor) and passive components (ferrite beads and coil inductors), a high level of impedance is achieved for wideband RF signals, thereby ensuring that the RF signal is not significantly diverted from the optical device, but without the components being too large in entirety to be used in a small module.

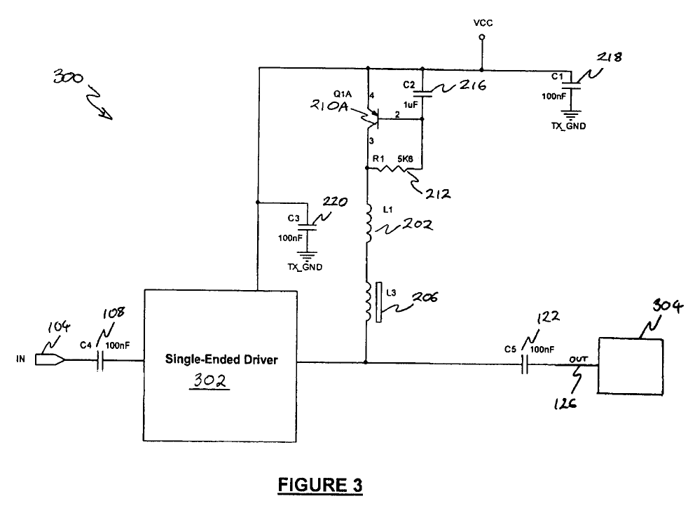

FIG. 3 shows another embodiment of the present invention. In this embodiment, the driver for driving the optical device 304 is a single-ended ended optical device driver 302. As a single-ended driver 302 only has a single output, only one transistor 210A and two inductors 202, 206 are required. Otherwise, the operation of the circuit is identical to that described with reference to FIG. 2.

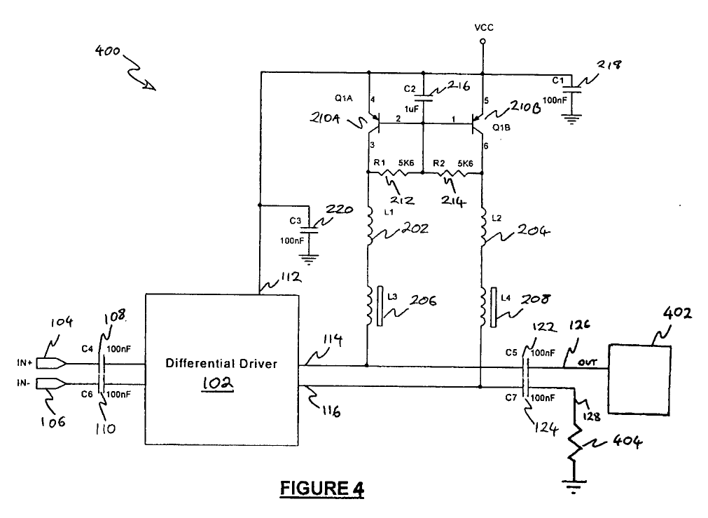

FIG. 4 shows another embodiment of the present invention. It is identical to that shown in FIG. 3, except that the optical device 402 is connected to only one of the outputs, and the other output is connected to ground via a dummy load 404.

In each embodiment, the supply Vcc is for the driver's output stage and also the pull-up. The driver may get a second power supply for its preceding stages or other parts of the circuitry.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

What is claimed is:

1. A circuit including a pair of radio frequency signal devices to each of which are connected in parallel a respective input or output and a respective dc bias input device for biasing the respective radio frequency signal device; each dc bias input device including a radio frequency transistor and at least two different types of inductors.

2. A circuit according to claim 1, wherein the pair of radio frequency signal devices together constitute part of a differential driver.

3. A circuit according to claim 1, wherein each dc bias input device includes a radio frequency transistor having a F_{T} value greater than or equal to 25 MHz.

4. A circuit according to claim 1, wherein the at least two types of inductors have different Q factors.

5. A circuit according to claim 1, wherein said two types of inductors include a coil inductor and a ferrite bead inductor.

6. A circuit according to claim 1, wherein the two dc bias input devices share a common power supply.

7. A system for producing an optical signal, including a pair of radio frequency signal input devices to each of which are connected in parallel a respective output and a respective dc bias input device for biasing the respective radio frequency signal input device; each dc bias input device including a radio frequency transistor and at least two different types of inductors; and further including an optic device connected to at least one of said outputs.

8. A system according to claim 7, wherein said optic device is connected to both of said outputs.

9. A system according to claim 7, wherein said optic device is connected to only one of said outputs, and a dummy load is connected to another of said outputs.

10. A system for producing an optical signal according to claim 7, wherein the two radio frequency signal input devices constitute part of a differential driver.

11. A system for producing an optical signal according to claim 7, wherein the optical device is a laser diode or an external modulator.

12. A system for producing an optical signal according to claim 7, wherein the two dc bias input devices share a common power supply.

13. A circuit including a radio frequency signal device to which are connected in parallel an input or output and a dc bias input device for biasing the radio frequency signal device:
the dc bias input device including a radio frequency transistor and at least two different types of inductors.

14. A circuit as claimed in claim 13, wherein the at least two types of inductors include a coil inductor and a ferrite bead inductor.

15. A circuit as claimed in claim 13, wherein the at least two types of inductors have different Q factors.

16. A circuit as claimed in claim 13, further including a capacitive element connected to said input or output in parallel with the dc bias input device and the radio frequency signal device.

17. A system for producing an optical signal including: a radio frequency signal input device to which are connected in parallel an optical device for producing an optical signal and a dc bias input device for biasing the radio frequency signal input device, the dc bias input device including a radio frequency transistor and at least two different types of inductors.

18. A system for producing an optical signal according to claim 17, wherein the optical device is a laser diode or an external modulator.
